(19) United States
(12) Patent Application Publication
(10) Pub. No.: US 2026/0220309 A1
(43) Pub. Date: Jul. 30, 2026

(54) FLEXIBLE BITSTREAM VERIFICATION AND INTEGRITY CHECKING FOR PROGRAMABLE LOGIC DEVICES, SYSTEMS, AND METHODS

(71) Applicant: Lattice Semiconductor Corporation, Hillsboro, OR (US)

(72) Inventors: Mehryar Rahmatian, San Jose, CA (US); Tim Vogt, Hillsboro, OR (US); Mamta Gupta, Fremont, CA (US); Eric Sivertson, Reno, NV (US); Cuauhtemoc Chavez Corona, Hillsboro, OR (US); Jordan Anderson, Centerville, UT (US)

(21) Appl. No.: 19/445,400

(22) Filed: Jan. 9, 2026

Related U.S. Application Data
(60) Provisional application No. 63/750,735, filed on Jan. 28, 2025.

(51) Int. Cl. G06F 21/64; G06F 21/60

(52) U.S. Cl. CPC G06F 21/64; G06F 21/602; G06F 21/606

(57) ABSTRACT

Various techniques are disclosed for providing improved and flexible security for configuration bitstreams to be used with programmable logic devices (PLDs). For example, a configuration bitstream may be encrypted with a key in a manner that generates one or more tags. The key and the tags may be provided to the PLD in a communication using a signature that may be verified by the PLD. When the encrypted configuration bitstream is subsequently received and decrypted by the PLD using the key, new tags generated by the decryption operation may be compared with the previously received tags to perform an integrity check on the decrypted configuration bitstream. The signature verification and integrity check operations may be separately performed by configured logic and dedicated hardware, respectively. Additional devices, systems and methods are also provided.

### CROSS-REFERENCE TO RELATED APPLICATION

This application claims the benefit of and priority to U.S. Provisional Patent Application No. 63/750,735 filed January 28, 2025 and entitled “FLEXIBLE BITSTREAM VERIFICATION AND INTEGRITY CHECKING FOR PROGRAMABLE LOGIC DEVICES, SYSTEMS, AND METHODS,” which is incorporated herein by reference it its entirety.

### TECHNICAL FIELD

This disclosure relates generally to programmable logic devices and, more specifically, to maintaining the security of configuration bitstreams for programmable logic devices.

### BACKGROUND

Programmable logic devices (PLDs), such as field programmable gate arrays (FPGAs), complex programmable logic devices (CPLDs), field programmable systems on a chip (FPSCs), or other types of programmable devices may be configured with various designs to implement desired functionality. The designs may be converted into synthesized components that are assigned to physical hardware components of the PLD configured to implement the designs. For example, configuration bitstreams may be stored in a memory and loaded (e.g., programmed) into appropriate hardware components to configure the PLD to implement a design.

PLD customers often dedicate considerable resources to developing designs for PLDs. As a result, maintaining the security of the associated configuration bitstreams and also protecting against subversion of desired operations or capability of the PLDs are important considerations for many PLD customers.

However, conventional techniques for maintaining the security of configuration bitstreams are often inconvenient and burdensome. For example, when a PLD is reconfigured with an updated configuration bitstream, security checks may be performed that require substantial processing. As a result, the PLD may exhibit significant latency before it is ready for use when booting.

### SUMMARY

Various techniques are disclosed for providing improved and flexible security for PLD configuration bitstreams. For example, a configuration bitstream may be encrypted with a key in a manner that generates one or more tags. The key and the tags may be provided to the PLD in a secure manner over a secure communication channel in a manner that includes a security signature that may be verified by the PLD. When the encrypted configuration bitstream is subsequently received and decrypted by the PLD using the key, new tags generated by the decryption operation may be compared with the previously received tags to perform an integrity check on the decrypted configuration bitstream. Advantageously, the verification and integrity operations may be separately performed in time and by different components (e.g., configured logic and dedicated hardware, respectively). As a result, the security of the configuration bitstream may be maintained in a flexible manner that provides increased performance.

In one embodiment, a method includes receiving an encryption key for an encrypted configuration bitstream for a programmable logic device (PLD); receiving a first set of tags for the encrypted configuration bitstream; receiving the encrypted configuration bitstream separately from the encryption key and the first set of tags; decrypting the encrypted configuration bitstream using the encryption key to generate a second set of tags; and comparing the first and second sets of tags to perform an integrity check for the encrypted configuration bitstream.

In another embodiment, a programmable logic device (PLD) includes a plurality of logic blocks configured to: receive an encryption key for an encrypted configuration bitstream for the PLD, receive a first set of tags for the encrypted configuration bitstream, receive the encrypted configuration bitstream separately from the encryption key and the first set of tags; and dedicated hardware blocks implemented to: decrypt the encrypted configuration bitstream using the encryption key to generate a second set of tags, and compare the first and second sets of tags to perform an integrity check for the encrypted configuration bitstream.

Additional embodiments directed to PLDs, devices, systems, and other methods are also disclosed.

### BRIEF DESCRIPTION OF THE DRAWINGS

FIG. 1 illustrates a block diagram of a PLD, a memory, an external system, and a trusted device in accordance with an embodiment of the disclosure.

FIG. 2 illustrates a block diagram of a non-volatile memory in accordance with an embodiment of the disclosure.

FIG. 3 illustrates a block diagram of configurable hardware components of a PLD in accordance with an embodiment of the disclosure.

FIG. 4 illustrates a process of preparing an encrypted configuration bitstream in accordance with an embodiment of the disclosure.

FIG. 5 illustrates a process of providing a configuration bitstream to a PLD from an external system in accordance with an embodiment of the disclosure.

FIG. 6 illustrates a process of providing a configuration bitstream to a PLD from a storage device in accordance with an embodiment of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Various techniques are provided for reducing PLD latency when booting and also for providing flexible security for PLD configuration bitstreams. In some embodiments, a configuration bitstream may be encrypted in a manner that generates one or more tags (e.g., also referred to as integrity check tags). For example, Advanced Encryption Standard with Galois/Counter Mode (AES-GCM) and/or other encryption techniques may be used. The encrypted configuration bitstream may be stored external to the PLD (e.g., in a customer database), locally on the PLD (e.g., in a non-volatile memory), and/or otherwise.

An encryption key (e.g., an AES key or other) and the tags (e.g., GCM tags or others) may be provided to the PLD in a secure manner and stored by the PLD for future use in decrypting the encrypted configuration bitstream and verifying its integrity. In some embodiments, the encryption key and the tags may be uniquely associated with the encrypted configuration bitstream. For example, different encryption keys may be used to encrypt different configuration bitstreams which results in different tags being generated for the different configuration bitstreams. As a result, different encrypted configuration bitstreams may be securely maintained in relation to each other such that a PLD in possession of an encryption key and/or tags associated with a first encrypted configuration bitstream would be unable to decrypt a second encrypted configuration bitstream without also being in possession of the different encryption key and tags uniquely associated with the second encrypted configuration bitstream, thereby reducing possible side channel attacks. In some embodiments, the encryption key may be implemented as a key that is different for each time the encrypted configuration bitstream is to be decrypted by the PLD to provide additional security (e.g., key rotation; a changing encryption key).

The PLD may verify the authenticity of the encryption key and the tags (e.g., using public-private key encryption or other techniques). In some embodiments, such verification may be performed by configured logic blocks (e.g., also referred to as soft intellectual property core blocks (soft IP) of the PLD). If the encryption key and tags are verified (e.g., authenticated), then the PLD may receive the encrypted configuration bitstream by requesting it (e.g., from a customer database) or accessing it (e.g., from local memory on the PLD).

Upon receiving the encrypted configuration bitstream, the PLD decrypts it using the previously verified encryption key and thereby generates a new set of tags (e.g., also referred to as integrity check tags) associated with the encrypted configuration bitstream. The PLD compares the newly generated tags with the previously received tags to check the integrity of the now decrypted configuration bitstream. In some embodiments, the decryption and integrity check may be performed by dedicated hardware (e.g., also referred to as hard intellectual property core blocks (hard IP)) of the PLD. As a result, the decryption and integrity check may be performed faster with reduced latency in comparison to conventional techniques that generally rely on configured logic blocks of the PLD to perform such operations.

Separating (e.g., bifurcating) the verification of the key and the tags from the decryption and integrity check provides numerous advantages. For example, this increases flexibility in the implementation of these features in the PLD. For example, as discussed, the verification may be performed by configured logic of the PLD, while the decryption and integrity check may be performed by dedicated hardware of the PLD which may provide reduced latency when booting the PLD.

Such separation also permits the verification to be performed using configured logic of the PLD in accordance with security protocols that may be updated in the future, while also permitting the decryption and integrity check to be performed rapidly using fixed (e.g., not configured) dedicated hardware. As a result, the updatable soft IP-based verification process may ensure that the security of the configuration bitstream is protected against future quantum computing threats that may subvert current security protocols by being upgradable in the future to post quantum computing (PQC) security protocols, while still permitting hardware acceleration to be used for the decryption and integrity check processes. In some embodiments, the security protocols may be updated in accordance with techniques set forth in U.S. Patent Application No. 18/916,352 filed October 15, 2024 entitled “ROOT OF TRUST CHAIN AND UPDATABLE SECURITY FOR PROGRAMMABLE LOGIC DEVICES, SYSTEMS, AND METHODS” which is incorporated herein by reference in its entirety.

Such separation also permits the PLD to detect changes to the configuration bitstream that may have occurred after the decryption key was received. For example, if the encrypted configuration bitstream has been modified (e.g., intentionally by a bad actor, unintentionally by a customer, and/or otherwise), this will result in different tags being generated during decryption that will not match the previously received tags that are associated with the original (e.g., unmodified) encrypted configuration bitstream.

In contrast, conventional techniques for managing encrypted configuration bitstreams are often significantly more burdensome. For example, conventional techniques may decrypt an encrypted configuration bitstream to provide an unencrypted configuration bitstream which is then parsed to perform an integrity check. Typically, these operations are performed by configured logic of the PLD and are therefore slower than dedicated hardware. Moreover, the conventional parsing of the unencrypted configuration bitstream may take substantially more time than comparing tags as provided by the present disclosure.

The PLD may be in communication with a storage device (e.g., which may be internal, external, part of, connected to, in communication with, and/or otherwise associated with PLD 100) such as a non-volatile memory (e.g., on a separate die from the PLD in the same microchip, on the same die as the PLD, on a separate microchip from the PLD, and/or otherwise implemented). The non-volatile memory stores various configuration bitstreams (e.g., which may also or alternatively stored by an external system), security protocols, metadata, data, and/or other information that may be accessed by the PLD under various circumstances.

The non-volatile memory may include a root of trust image (RTI) for the PLD that is immutably stored in the non-volatile memory, for example, an inherently trusted party (e.g., a manufacturer, customer, nation state, and/or other inherently trusted entity). The RTI may be an inherently trusted default configuration for hardware components of the PLD and therefore may be used to configure the hardware components without requiring authentication before each use. For example, the default configuration provided by the RTI may comprise a plurality of default operations to be performed by the hardware components when configured by the default configuration in response to a cold boot (e.g., power on reset) of the PLD and/or a reconfiguration performed in response to an appropriate trigger.

The non-volatile memory may include a root of trust image extension (RTIE) that identifies default security protocols used by the PLD for encrypting and/or decrypting: configuration bitstreams of the PLD; data stored, transmitted, and/or received by the PLD and/or the non-volatile memory; and/or other purposes as appropriate. Similar to the RTI, the RTIE may also be an inherently trusted default configuration for hardware components of the PLD and therefore may be used to configure the hardware components without requiring authentication before each use. Significantly, the RTIE may be replaced in the non-volatile memory (e.g., upgraded in the field) with an updated RTIE having updated security protocols in a manner that permits the PLD to operate with improved security protocols even after the PLD has been deployed. As a result, the PLD may be easily adapted to use improved security protocols in the event that the original RTIE security protocols become obsolete, compromised, and/or less effective (e.g., due to advances in quantum computing and/or otherwise).

The non-volatile memory may include one or more configuration bitstreams that may be authenticated and used to configure the hardware components of the PLD in place of the RTI default configuration. For example, a configuration bitstream may be provided with a trusted security block that, when detected by the PLD configured with the RTI default configuration, permits the PLD to trust the configuration bitstream. For example, in some embodiments, the trusted security block may restrict access to the non-volatile memory by the hardware components configured by the configuration bitstream. As a result, the configuration bitstream may provide a second root of trust in a root of trust chain with the first root of trust provided by the RTI default configuration.

In some embodiments, a previously authenticated configuration bitstream may be identified as such by metadata stored by the non-volatile memory. As a result, the PLD may not be required to reauthenticate the configuration bitstream if the metadata identifies that it has been previously authenticated.

The non-volatile memory may include various additional data and metadata as further discussed herein.

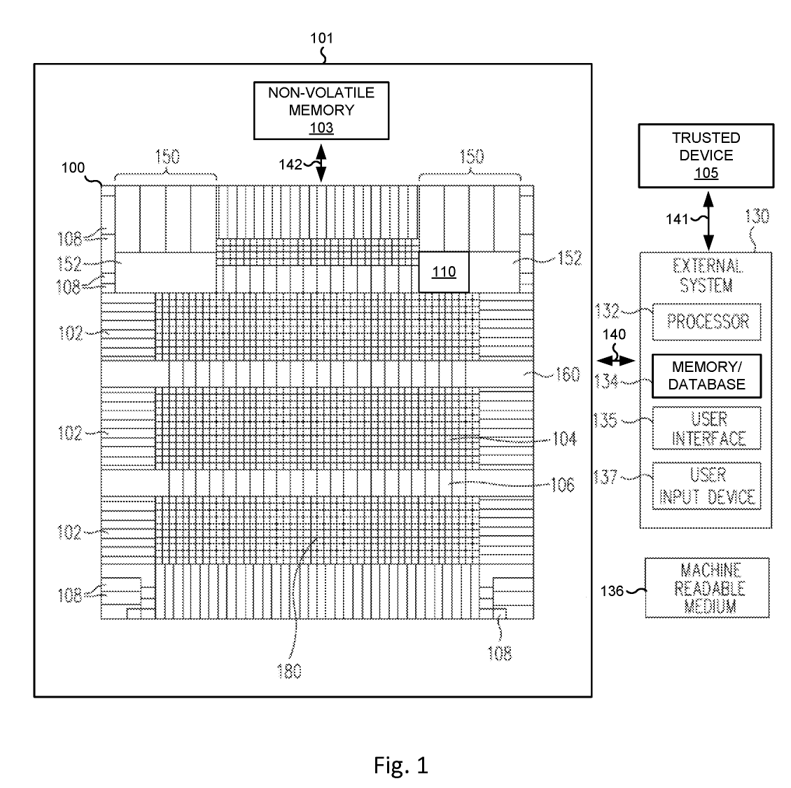

Referring now to the drawings, FIG. 1 illustrates a block diagram of a PLD 100, a non-volatile memory 103, an external system 130, and a trusted device 105 in accordance with an embodiment of the disclosure.

In the illustrated embodiment, PLD 100 and non-volatile memory 103 are associated with each other and implemented on separate dies provided within the same microchip 101. Other associations between PLD 100 and non-volatile memory are also contemplated, such as the implementation of PLD 100 and non-volatile memory 103 on the same die together, on separate dies and separate microchips, non-volatile memory 103 being implemented as part of PLD 100, and/or other implementations as discussed.

PLD 100 (e.g., a field programmable gate array (FPGA)), a complex programmable logic device (CPLD), a field programmable system on a chip (FPSC), or other type of programmable device) generally includes various physical hardware components (also referred to as configurable hardware components) such as input/output (I/O) blocks 102, logic blocks 104 (e.g., also referred to as programmable logic blocks (PLBs), programmable functional units (PFUs), or programmable logic cells (PLCs)) and others as discussed that may be configured in accordance with various combinations of RTI configurations, RTIE configurations, and/or configuration bitstreams stored in non-volatile memory 103 and further discussed herein.

I/O blocks 102 provide I/O functionality (e.g., to support one or more I/O and/or memory interface standards) for PLD 100, while logic blocks 104 provide logic functionality (e.g., look-up table (LUT) logic or logic gate array-based logic) for PLD 100. Additional I/O functionality may be provided by serializer/deserializer (SERDES) blocks 150 and physical coding sublayer (PCS) blocks 152. In various embodiments, I/O blocks 102 and SERDES blocks 150 may route signals to and from associated external ports (e.g., physical pins) of PLD 100. PLD 100 may also include hard IP 160 implemented to provide additional functionality (e.g., substantially predetermined functionality provided in hardware that may be configured with less programming than logic blocks 104).

PLD 100 may also include memory blocks 106 (e.g., blocks of EEPROM memory blocks, RAM (e.g., static and/or dynamic) memory blocks, and/or flash memory blocks), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In various embodiments, routing resources 180 may include user configurable routing resources and hardwired signal paths. In general, the various physical hardware components of PLD 100 may be used to perform their intended functions for desired applications, as would be understood by one skilled in the art.

For example, I/O blocks 102 may be used for programming PLD 100, such as memory blocks 106 (e.g., including volatile configuration memory) or transferring information (e.g., various types of data and/or control signals) to/from PLD 100 through various external ports as would be understood by one skilled in the art. I/O blocks 102 may provide a first programming port (which may represent a central processing unit (CPU) port, a peripheral data port, a serial peripheral interface (SPI), and/or a sysCONFIG programming port) and/or a second programming port such as a joint test action group (JTAG) port (e.g., by employing standards such as Institute of Electrical and Electronics Engineers (IEEE) 1149.1 or 1532 standards). I/O blocks 102 typically, for example, may be included to receive configuration bitstreams (e.g., over connection 142) to configure PLD 100 for its intended use and to support serial or parallel device configuration and information transfer with SERDES blocks 150, PCS blocks 152, hard IP 160, and/or logic blocks 104 as appropriate.

For example, in some embodiments any of the various components discussed herein may be configured in response to a PLD 100 (e.g., implemented by appropriate logic such as one or more processors, finite state machines, and/or other hardware and/or software) passing RTI configurations, RTIE configurations, configuration bitstreams, and/or other data (e.g., any of which may be stored in non-volatile memory 103 and/or elsewhere as appropriate) by routing resources 180. In some embodiments, configurations and/or data may be stored by non-volatile memory 103, locally on PLD 100 (e.g., in one or more memory blocks 106) and/or stored externally from PLD 100 (e.g., in a memory and/or database 134 of an external system 130).

It should be understood that the number and placement of the various components are not limiting and may depend upon the desired application. For example, various components may not be required for a desired application or design specification (e.g., for the type of programmable device selected).

Furthermore, it should be understood that the components are illustrated in block form for clarity and that various components would typically be distributed throughout PLD 100, such as in and between logic blocks 104, hard IP 160, and routing resources 180 to perform their conventional functions (e.g., storing configurations that configure PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

Non-volatile memory 103 (e.g., a flash memory and/or any other desired type of non-volatile memory) may store various RTI configurations, RTIE configurations, configuration bitstreams, and/or other data for reading from, writing to, and/or configuring hardware components of PLD 100 as further discussed herein. Non-volatile memory 103 may communicate with PLD 100 through connection 142 which may be implemented in any appropriate manner. For example, in some embodiments, connection 142 may be an SPI connection (e.g., actual or emulated) in communication with I/O blocks 102.

Although non-volatile memory 103 is illustrated in communication with PLD 100 through connection 142, other connections are contemplated. For example, in some embodiments, non-volatile memory 103 may communicate directly with external system 130, trusted device 105, and/or other systems or devices as appropriate.

System 130 (e.g., also referred to as an external device) may be used to generate a desired configuration bitstream of PLD 100 in accordance with a customer design. As further discussed herein, system 130 may add a trusted security block to the configuration bitstream to provide a minimum level of security for the configuration bitstream. Such configurations may be stored in non-volatile memory 103 and/or elsewhere as appropriate and used by PLD 100 to configure various hardware components of PLD 100.

In the illustrated embodiment, system 130 is implemented as a computer system. In this regard, system 130 includes, for example, one or more processors 132 (e.g., implemented by appropriate logic as discussed with regard to PLD 100) which may be configured to execute instructions, such as software instructions, provided in one or more memories/databases 134 and/or stored in non-transitory form in one or more non-transitory machine-readable mediums 136 (e.g., a memory or other appropriate storage medium internal or external to system 130). For example, in some embodiments, system 130 may run a PLD configuration application, such as Lattice Radiant software available from Lattice Semiconductor Corporation to permit a user (e.g., a customer or manufacturer) to create a desired configuration and generate a corresponding configuration bitstream to program PLD 100.

System 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100. As shown, system 130 may communicate with PLD 100 over a connection 140.

In some embodiments, system 130 may be a test bed operated by a predetermined inherently trusted party (e.g., a manufacturer, a customer, a nation state, and/or other trusted party) to generate and/or store RTI configurations, RTIE configurations, and/or other configurations and data in non-volatile memory 103 (e.g., during manufacture of microchip 101).

Trusted device 105 (e.g., also referred to as a trusted system) is separate from microchip 101 and system 130 (e.g., but may be in communication therewith in some embodiments) and is operable to independently detect the presence of the trusted security block in the configuration bitstream generated by system 130 and therefore verify that the configuration bitstream includes a minimum level of security as discussed. Trusted device 105 may be implemented with any of the various components of system 130 discussed herein to provide such features. Trusted device 105 may communicate with system 130 over a connection 141 (e.g., to receive configuration bitstreams for verification).

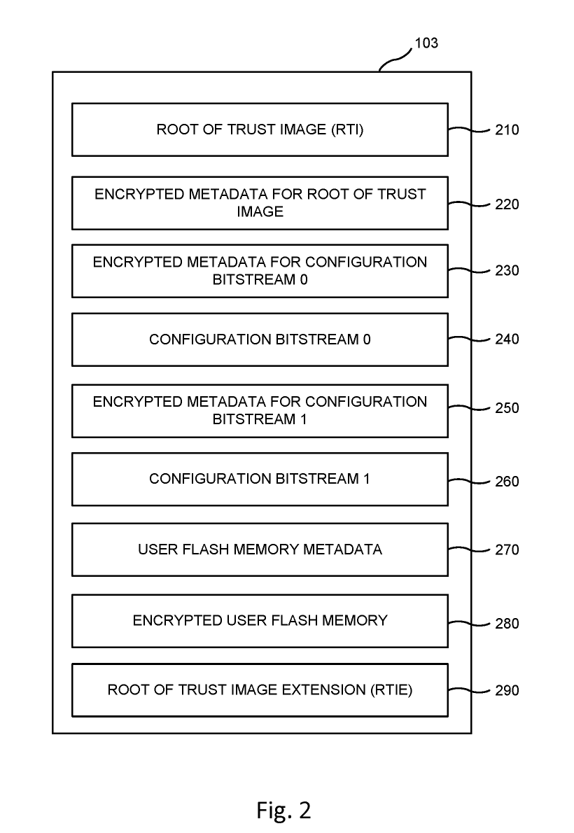

FIG. 2 illustrates a block diagram of non-volatile memory 103 in accordance with an embodiment of the disclosure. As discussed, non-volatile memory 103 stores various information that may be used to configure PLD 100 and/or facilitate its operation in accordance with various default configurations, configuration bitstreams, and security protocols. The various configurations (e.g., configuration bitstreams) stored in non-volatile memory 103 may be loaded (e.g., programmed) into configurable hardware components (e.g., by a configuration engine 110) of PLD 100 to configure or reconfigure such hardware components as discussed herein.

RTI 210 is an inherently trusted default configuration for hardware components of PLD 100 that may not require authentication before each use. RTI 210 may be immutably stored in non-volatile memory 103 (e.g., addresses of non-volatile memory 103 that store RTI 210 may be disabled from being written to by PLD 100) by a manufacturer or other inherently trusted party. RTI 210 may be a configuration bitstream that may comprise a plurality of default operations to be performed by the configurable hardware components of PLD 100 in response to a power on reset (e.g., a cold boot and/or a reconfiguration performed in response to an appropriate trigger) of PLD 100.

RTIE 290 is an inherently trusted set of security protocols used by PLD 100 that may not require authentication before each use. RTIE 290 may be provided by a manufacturer or other inherently trusted party. RTIE 290 may provide security protocols for encrypting and/or decrypting: configuration bitstreams of the PLD; data stored, transmitted, and/or received by the PLD and/or the non-volatile memory; and/or other purposes as appropriate. RTIE 290 may be replaced (e.g., upgraded in the field) with an updated RTIE having updated security protocols in a manner that permits PLD 100 to operate with improved security protocols even after PLD 100 has been deployed to a customer.

Metadata 220 is encrypted metadata used by RTI 210, such as cryptographic keys used by various security protocols implemented by RTIE 290 and also an identification of whether PLD 100 should be further configured with RTIE 290 during operation.

Configuration bitstream 240 (e.g., also referred to as configuration 0 or a first configuration bitstream) configures the hardware components of PLD 100 in place of RTI 210 or another configuration (e.g., configuration bitstream 260). For example, after PLD 100 is configured by RTI 210, configuration bitstream 240 may be authenticated (e.g., by the presence of a trusted security block and/or metadata 230 identifying a previous authentication as discussed) and loaded into PLD 100 to configure hardware components to implement a customer design. As discussed, configuration bitstream 240 may provide a second root of trust in a root of trust chain with the first root of trust provided by RTI 210. Metadata 230 is encrypted metadata used by configuration bitstream 240 and may identify whether configuration bitstream 240 has been previously authenticated as discussed.

Configuration bitstream 260 (e.g., also referred to as configuration 1 or a second configuration bitstream) configures the hardware components of PLD 100 in place of RTI 210 or another configuration (e.g., configuration bitstream 240). For example, after PLD 100 is configured by configuration bitstream 240, then configuration bitstream 260 may be authenticated (e.g., by the presence of a trusted security block and/or metadata 250 identifying a previous authentication as discussed) and loaded into PLD 100 to configure hardware components to implement a customer design. As discussed, configuration bitstream 260 may provide a third root of trust in a root of trust chain with the first root of trust provided by RTI 210 and the second root of trust provided by configuration bitstream 240. In another embodiment, the root of trust chain may include only RTI 210 and configuration bitstream 260. Metadata 250 is encrypted metadata used by configuration bitstream 260 and may identify whether configuration bitstream 260 has been previously authenticated as discussed.

Configuration bitstreams 240/260 may be encrypted when stored in in non-volatile memory 103. In addition and/or alternatively, configuration bitstreams 240/260 and any other desired information identified in non-volatile memory 103 may be stored in memory/database 134 of external system 130.

Metadata 270 is additional metadata that may be populated by a customer and associated with configuration bitstream 240 and/or 260. User memory 280 is encrypted memory that may be populated by a user of PLD 100 and may be used by PLD 100 during runtime and/or otherwise as appropriate.

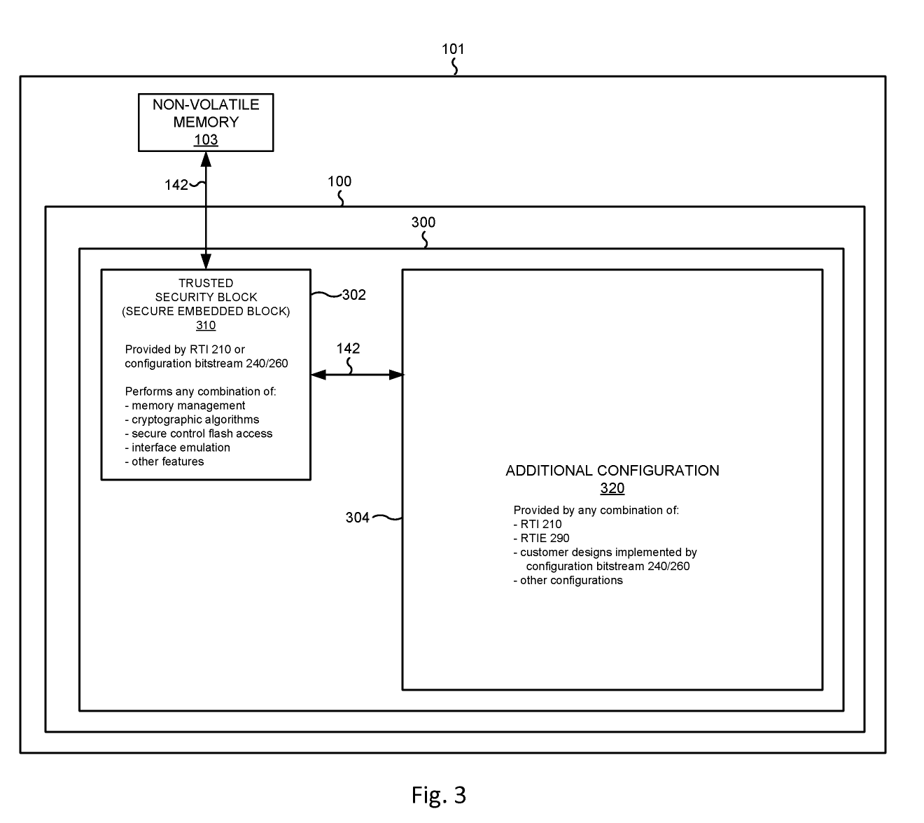

FIG. 3 illustrates a block diagram of configurable components 300 of PLD 100 in accordance with an embodiment of the disclosure. As similarly illustrated with regard to FIG. 1, PLD 100 and non-volatile memory 103 may be implemented on separate dies provided in the same microchip 101 and may communicate over connection 142.

Components 300 may include various physical hardware components such as I/O blocks 102, logic blocks 104, and others as discussed and may be configured in accordance with various combinations of RTI configurations, RTIE configurations, and/or configurations stored in non-volatile memory 103.

For example, a portion 302 of components 300 may be configured with a trusted security block 310 that provides various security features to facilitate the interfacing of non-volatile memory 103 with components 300 including but not limited to memory management, cryptographic algorithms, secure control flash access, and interface emulation (e.g., for SPI-based communications or otherwise). Another portion 304 of components 300 may be configured with an additional configuration 320 that may include various combinations of RTI 210 configurations, RTIE 290 configurations, configuration bitstreams 240/260 (e.g., to implement customer designs), and/or other configurations stored in non-volatile memory 103 and loaded (e.g., programmed) into portion 302 of components 300.

As shown, direct communication between components 300 and non-volatile memory 103 is limited to trusted security block 310. Additional configuration 320 cannot communicate directly with non-volatile memory 103. Instead, communications between additional configuration 320 and non-volatile memory 103 are restricted (e.g., monitored, limited, and/or otherwise managed) by trusted security block 310 which provides a minimum level of security to prevent additional configuration 320 from directly accessing non-volatile memory 103 and thereby prevents additional configuration 320 from subverting desired operations or capabilities of PLD 100 through unauthorized changes to the various information stored in non-volatile memory 103).

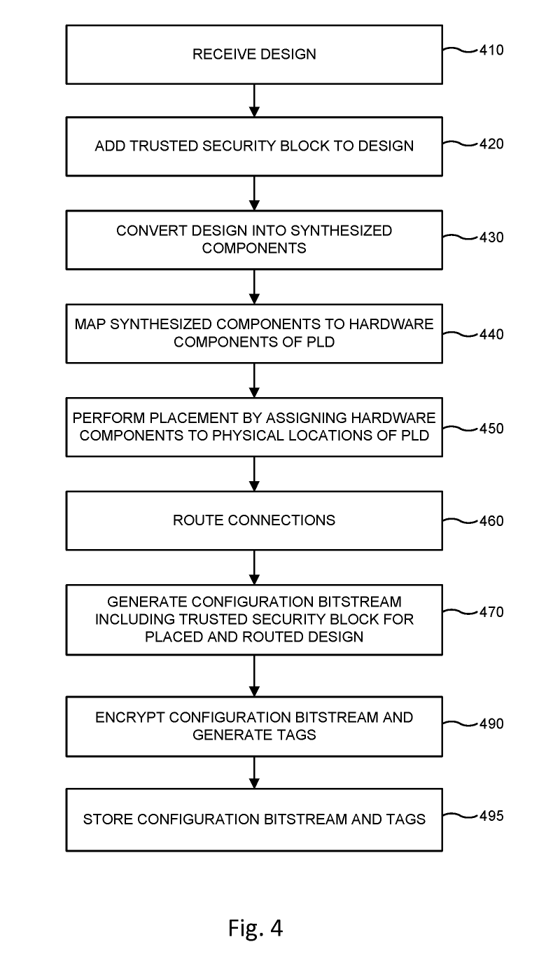

FIG. 4 illustrates a process of preparing encrypted configuration bitstream 240/260 for PLD 100 in accordance with an embodiment of the disclosure. For example, the process of FIG. 4 may be performed by system 130 running a PLD configuration application such as Lattice Radiant Software as discussed. In some embodiments, the various files and information referenced in FIG. 4 may be stored, for example, in one or more databases and/or other data structures in memory/database 134, machine readable medium 136, non-volatile memory 103, and/or otherwise.

In operation 410, system 130 receives a design (e.g., a customer design) that specifies desired functionality of PLD 100. For example, a user (e.g., customer) may interact with system 130 (e.g., through user input device 137 and hardware description language (HDL) code representing the design) to identify various features of the design (e.g., operations to be performed by PLD 100 when configured and/or other features). In some embodiments, the design may be provided in a register transfer level (RTL) description (e.g., a gate level description). System 130 may perform one or more rule checks to confirm that the design describes a valid configuration of PLD 100. For example, system 130 may reject invalid configurations and/or request the user to provide new design information as appropriate.

In operation 420, system 130 adds trusted security block 310 to the design to provide such features to the resulting configuration bitstream as discussed.

In operation 430, system 130 synthesizes the design to convert the design (including both the customer design and the trusted security block 310) into a plurality of synthesized components (e.g., logical constructs representing operations performed by the design). For example, operation 430 may include converting the design into a netlist (e.g., a synthesized RTL description) identifying an implementation of the design as a plurality of synthesized components (e.g., also referred to as logic components or netlist components). In this regard, the synthesized components may identify logic, hardware functions, and/or other design features that may be subsequently mapped to various types of hardware components provided by PLD 100 discussed herein in operation 540. In some embodiments, the netlist may be stored in Verilog format in a Unified Database (UDB) file and/or Electronic Design Interchange Format (EDIF) in a Native Generic Database (NGD) file.

In some embodiments, operation 430 may include performing an optimization process on the design to reduce propagation delays, consumption of PLD resources and interconnections, and/or otherwise optimize the performance of PLD 100 when configured with the design. For example, the optimization process may be performed on the netlist representing the synthesized design to provide an improved netlist representing an improved synthesized design.

In operation 440, system 130 performs a mapping process that identifies various types of hardware components of PLD 100 that may be used to implement the synthesized components identified in operation 430.

In operation 450, system 130 performs a placement process to assign the types of hardware components mapped in operation 440 to the actual components 300 residing at specific physical locations of PLD 100, and thus determine a layout for PLD 100. In some embodiments, the placement may be performed on one or more previously-stored UDB and/or NGD files, with the placement results stored as another physical design file.

In operation 460, system 130 performs a routing process to route connections (e.g., using routing resources 180) among the physical components 300 of PLD 100 based on the placement layout determined in operation 450 to realize the physical interconnections among the placed components. In some embodiments, the routing may be performed on one or more previously-stored UDB and/or NGD files, with the routing results stored as another physical design file. Thus, following operation 560, one or more physical design files may be provided which specify the design after it has been synthesized (e.g., converted and optimized), mapped, placed, and routed for PLD 100 (e.g., by combining the results of the corresponding previous operations).

In operation 470, system 130 generates configuration bitstream 240/260 for the synthesized, mapped, placed, and routed design. For example, the generated configuration bitstream 240/260 may be a configuration bitstream compatible for storage in memory/database 134 and/or non-volatile memory 103, and used for configuring components 300.

In operation 490, system 130 encrypts configuration bitstream 240/260 (e.g., using AES-GCM encryption or other techniques) and generates associated tags.

In operation 495, system 130 stores the encrypted configuration bitstream and the tags in memory/database 134 and/or in a storage device such as non-volatile memory 103.

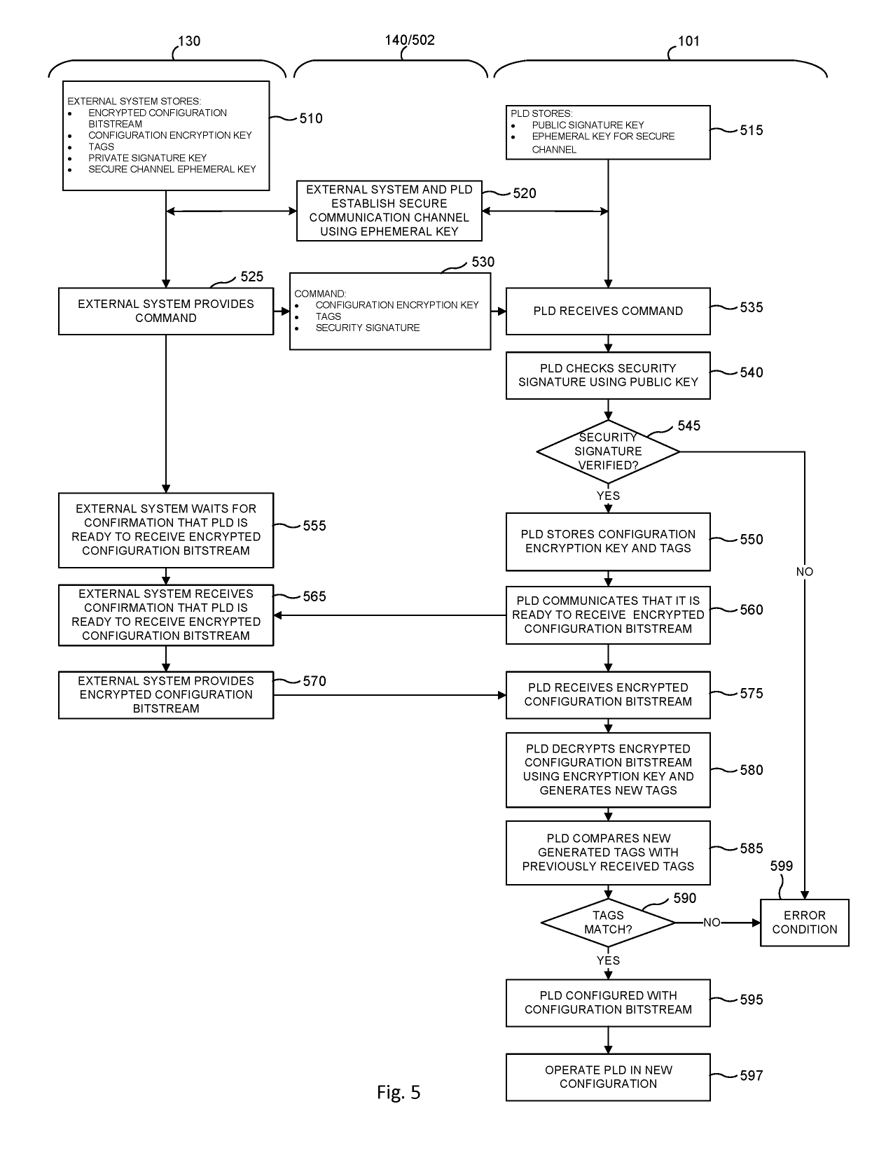

FIG. 5 illustrates a process of providing a configuration bitstream (e.g., configuration bitstream 240/260) to PLD 100 from external system 130 in accordance with an embodiment of the disclosure. .

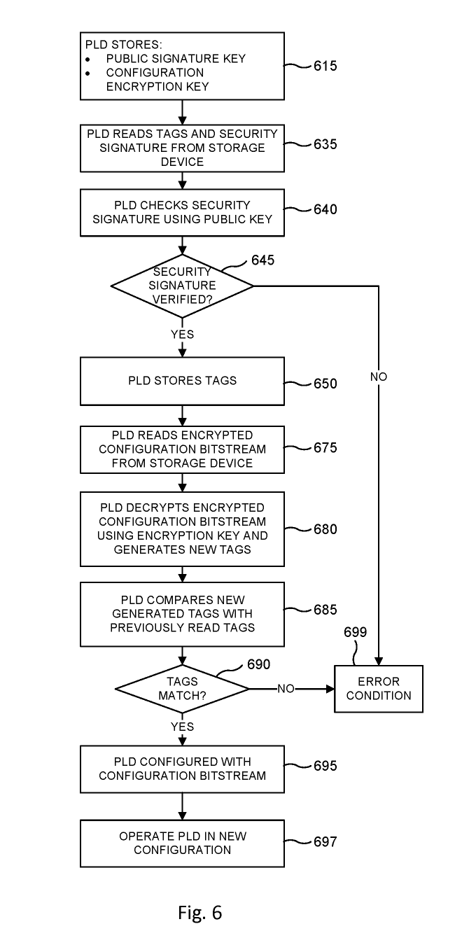

PLD 100 includes non-volatile memory 103 storing various data. PLD 100 also includes logic blocks 104 that may be configured with RTI 210 and RTIE 290. For example, prior to the process of FIG. 5, PLD 100 may have been booted (e.g., powered on or awakened) and had its logic blocks 104 configured with RTI 210 and RTIE 290. In this regard, logic blocks 104 configured with RTI 210 and RTIE 290 are soft IP blocks that may perform various operations of FIGS. 5 and 6 as discussed herein. PLD 100 also includes hard IP blocks 160 (e.g., implementing a hardened security engine) that provide dedicated hardware for performing various operations of FIG. 5 as discussed herein.

Accordingly, it will be appreciated that the soft IP blocks provided by configured logic blocks 104 may be updated by reconfiguring them through new configuration bitstreams to take advantage of new security protocols. Meanwhile, the hard IP blocks 160 provide hardware acceleration for performing various operations of FIGS. 5 and 6 as discussed herein.

In FIG. 5, various operations are discussed as being performed by PLD 100, while other operations may be performed by external system 130. In this regard, FIG. 5 will be discussed primarily in relation to embodiments where an encrypted configuration bitstream and its associated tags and key are stored by memory/database 134 of external system 130.

In operations 510 and 515, external system 130 and PLD 100 store various data for use in the process of FIG. 5. For example, the data identified in operations 510 and 515 may be previously received by and/or generated by external system 130, PLD 100, and/or other devices based on previous operations and/or communications between such devices and systems.

Specifically, in operation 510, external system 130 stores (e.g., in memory/database 134) various data including an encrypted configuration bitstream, a configuration encryption key, tags (e.g., generated in operation 490 as discussed), a private signature key, and a secure channel ephemeral key.

The encrypted configuration bitstream may be a configuration bitstream (e.g., configuration bitstream 240/260) that has been encrypted (e.g., previously encrypted by external system 130 and/or other devices) using the stored configuration encryption key in a manner that generates the stored tags. The private signature key is used to provide a verifiable security signature using an asymmetric private-public key security arrangement as discussed herein. The secure channel ephemeral key is used to establish a secure communication channel between external system 130 and PLD 100 as discussed herein.

In operation 515, logic blocks 104 of PLD 100 configured with RTI 210 operate to store (e.g., in memory blocks 106, non-volatile memory 103, and/or otherwise) various data including a public signature key and a secure channel ephemeral key.

The public signature key is used to provide a verifiable security signature using an asymmetric private-public key security arrangement as discussed herein. The secure channel ephemeral key is the same secure channel ephemeral key stored by external system 130 and is used to establish the secure communication channel between external system 130 and PLD 100 as discussed herein.

In operation 520, external system 130 and logic blocks 104 of PLD 100 configured with RTI 210 establish a secure communication channel 502 between them using the ephemeral key stored by each and in accordance with any appropriate encryption technique. As a result, further communications between external system 130 and PLD 100 may be performed in a secure manner.

In operation 525, external system 130 generates and provides a command 530 to PLD 100 over secure communication channel 502. For example, command 530 may be a data structure that includes various data including the configuration encryption key and the tags generated in operation 490 and stored by external system 130 in operation 495 as discussed. In addition, command 530 may be signed by the private signature key stored by external system 130. For example, in some embodiments, command 530 may be signed by generating a hash value of command 530 and encrypting the hash value using the private signature key.

In operation 535, logic blocks 104 of PLD 100 configured with RTI 210 receive command 530. Because command 530 is provided over the previously established secure communication channel 502, its contents (e.g., the configuration encryption key, tags, and security signature) will be secure and unable to be decrypted by third parties. In addition, because command 530 is signed using the private signature key known only to external system 130, PLD 100 may verify whether command 530 (and the data contained therein) has originated from a trusted external system 130 rather than a third party.

Accordingly, in operation 540, logic blocks 104 of PLD 100 configured with RTI 210 check the security signature of command 530 by decrypting the security signature using the public signature key stored by PLD 100. For example, such decryption may be performed by logic blocks 104 of PLD 100 configured with RTIE 290 in response to a request from logic blocks 104 of PLD 100 configured with RTI 210.

In operation 545, if the security signature is successfully verified using the public signature key, then PLD 100 will have confirmed that command 530 and the data included therein is authentic and the process continues to operation 550. Otherwise, PLD 100 detects an error and the process ends in operation 599.

For example, upon reaching operation 599 from operation 545, PLD 100 will be unable to verify that the configuration encryption key and the tags received in command 530 are authentic. As a result, in operation 599, PLD 100 may take various actions such as communicating the error to external system 130, operating in accordance with a current configuration (e.g., RTI 210 and/or RTIE 290), and/or other actions as appropriate.

In operation 550, logic blocks 104 of PLD 100 configured with RTI 210 store (e.g., in memory blocks 106, non-volatile memory 103, and/or otherwise) the configuration encryption key and the tags received in command 530 for future use by hard IP blocks 160. Meanwhile, in operation 555, external system 130 waits for confirmation that PLD 100 is ready to receive the encrypted configuration bitstream.

In operation 560, as a result of verifying that command 530 is authentic (e.g., by successfully verifying its security signature), logic blocks 104 of PLD 100 configured with RTI 210 communicate a confirmation to external system 130 over secure communication channel 502 that PLD 100 is ready to receive the encrypted configuration bitstream.

In operation 565, external system 130 receives the confirmation from PLD 100. In operation 570, external system 130 provides (e.g., transmits) the encrypted configuration bitstream to PLD 100 over secure communication channel 502. In operation 575, hard IP blocks 160 of PLD 100 receive the encrypted configuration bitstream from external system 130 over secure communication channel 502.

In operation 580, hard IP blocks 160 of PLD 100 decrypt the encrypted configuration bitstream using the encryption key included in command 530. As discussed, the encrypted configuration bitstream may be encrypted using an encryption technique (e.g., AES-GCM encryption or other techniques) that generates associated tags when decrypted. Accordingly, also in operation 580, hard IP blocks 160 of PLD 100 generate a new set of tags as a result of the decryption. Accordingly, it will be appreciated that following operation 580, PLD 100 will have in its possession two sets of tags: the previously generated tags received from external system 130 through command 530; and the newly generated tags provided by PLD 100 from the decryption.

In operation 585, hard IP blocks 160 of PLD 100 compare the newly generated tags with the previously generated tags. If the encrypted configuration bitstream stored by external system 130 is the same encrypted configuration bitstream received by PLD 100 in operation 575, then then previously generated tags will match the newly generated tags. However, if the encrypted configuration bitstream received by PLD 100 in operation 575 has changed, then different tags will be generated when it is decrypted in operation 580. Therefore, by comparing the previously generated and newly generated tags, PLD 100 may verify the integrity of the encrypted configuration bitstream received in operation 575 (e.g., confirming that it is indeed the same encrypted configuration bitstream stored by external system 130 and used to provide the previously generated tags).

In operation 590, if the tags match (e.g., are verified), then PLD 100 will have verified the integrity of the encrypted configuration bitstream received in operation 575 and the process continues to operation 595. Otherwise, PLD 100 detects an error and the process ends in operation 599.

For example, upon reaching operation 599 from operation 590, PLD 100 will be unable to verify the integrity of the encrypted configuration bitstream received in operation 575. As a result, in operation 599, PLD 100 may take various actions as discussed.

In operation 595, configuration engine 110 of PLD 100 configures (e.g., updates) logic blocks 104 and/or other components in accordance with the decrypted configuration bitstream.

In operation 597, PLD 100 operates (e.g., awakens, restarts, reboots, or otherwise) in accordance with the now-configured decrypted configuration bitstream.

As previously noted, various operations of FIG. 5 have been discussed primarily in relation to embodiments where an encrypted configuration bitstream and its associated tags and key are stored by memory/database 134 of external system 130. However, in other embodiments, the encrypted configuration bitstream and its associated tags (and optionally its key) may be provided by a storage device (e.g., which may be internal, external, part of, connected to, in communication with, and/or otherwise associated with PLD 100) such as non-volatile memory 103.

Accordingly, FIG. 6 illustrates a process of providing a configuration bitstream (e.g., configuration bitstream 240/260) to PLD 100 from a storage device such as non-volatile memory 103. Although non-volatile memory 103 is discussed in FIG. 6, any appropriate storage device may be used and implemented in any appropriate manner as discussed herein.

In operation 615, PLD 100 stores various data for use in the process of FIG. 6 as similarly discussed with regard to operation 515 of FIG. 5. More specifically, in operation 615, logic blocks 104 of PLD 100 configured with RTI 210 operate to store (e.g., in memory blocks 106, non-volatile memory 103, and/or otherwise) various data including a public signature key (e.g., to provide a verifiable security signature using an asymmetric private-public key security arrangement as discussed herein) and a configuration encryption key (e.g., to decrypt an encrypted configuration bitstream, such as configuration bitstream 240/260, that has been encrypted using the stored configuration encryption key as discussed with regard to FIG. 5).

In operation 635, logic blocks 104 of PLD 100 configured with RTI 210 read (e.g., receive, retrieve, and/or otherwise obtain) from a storage device (e.g., non-volatile memory 103 or other appropriate storage device) tags that have been previously generated (e.g., in operation 490) for an encrypted configuration bitstream stored by the storage device (e.g., in operation 495). In addition, the tags read in operation 635 may be signed by a private signature key that is associated with the public signature key discussed in operation 615 for an asymmetric private-public key security arrangement (e.g., operation 635 may include reading a security signature from the storage device).

In operation 640, logic blocks 104 of PLD 100 configured with RTI 210 check the security signature read in operation 635 by decrypting the security signature using the public signature key stored by PLD 100. For example, such decryption may be performed by logic blocks 104 of PLD 100 configured with RTIE 290 in response to a request from logic blocks 104 of PLD 100 configured with RTI 210.

In operation 645, if the security signature is successfully verified using the public signature key, then PLD 100 will have confirmed that the tags read in operation 635 are authentic and the process continues to operation 650. Otherwise, PLD 100 detects an error and the process ends in operation 699.

For example, upon reaching operation 699 from operation 645, PLD 100 will be unable to verify that the tags read in operation 635 are authentic. As a result, in operation 699, PLD 100 may take various actions such as communicating the error, operating in accordance with a current configuration (e.g., RTI 210 and/or RTIE 290), and/or other actions as appropriate.

In operation 650, logic blocks 104 of PLD 100 configured with RTI 210 store (e.g., in memory blocks 106, non-volatile memory 103, and/or otherwise) the tags read in operation 635 for future use by hard IP blocks 160.

In operation 675, logic blocks 104 of PLD 100 configured with RTI 210 read (e.g., receive, retrieve, and/or otherwise obtain) the encrypted configuration bitstream from the storage device and provide it to hard IP blocks 160 of PLD 100.

In operation 680, hard IP blocks 160 of PLD 100 decrypt the encrypted configuration bitstream using the encryption key previously stored in operation 615. As discussed, the encrypted configuration bitstream may be encrypted using an encryption technique (e.g., AES-GCM encryption or other techniques) that generates associated tags when decrypted. Accordingly, also in operation 680, hard IP blocks 160 of PLD 100 generate a new set of tags as a result of the decryption. Accordingly, it will be appreciated that following operation 680, PLD 100 will have in its possession two sets of tags: the previously generated tags read from the storage device; and the newly generated tags provided by PLD 100 from the decryption.

In operation 685, hard IP blocks 160 of PLD 100 compare the newly generated tags with the previously read tags to verify the integrity of the encrypted configuration bitstream read in operation 675 as similarly discussed for FIG. 5.

In operation 690, if the tags match (e.g., are verified), then PLD 100 will have verified the integrity of the encrypted configuration bitstream read in operation 675 and the process continues to operation 695. Otherwise, PLD 100 detects an error and the process ends in operation 699.

For example, upon reaching operation 699 from operation 690, PLD 100 will be unable to verify the integrity of the encrypted configuration bitstream read in operation 675. As a result, in operation 699, PLD 100 may take various actions as discussed.

In operation 695, configuration engine 110 of PLD 100 configures (e.g., updates) logic blocks 104 and/or other components in accordance with the decrypted configuration bitstream.

In operation 697, PLD 100 operates (e.g., awakens, restarts, reboots, or otherwise) in accordance with the now-configured decrypted configuration bitstream.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
receiving an encryption key for an encrypted configuration bitstream for a programmable logic device (PLD);
receiving a first set of tags for the encrypted configuration bitstream;
receiving the encrypted configuration bitstream separately from the encryption key and the first set of tags;
decrypting the encrypted configuration bitstream using the encryption key to generate a second set of tags; and
comparing the first and second sets of tags to perform an integrity check for the encrypted configuration bitstream.

2. The method of claim 1, further comprising authenticating the encryption key and the first set of tags.

3. The method of claim 2, wherein:
the authenticating is performed by configured logic blocks of the PLD; and
the decrypting and the comparing are performed by dedicated hardware of the PLD.

4. The method of claim 2, wherein the authenticating comprises verifying a security signature associated with the encryption key and the first set of tags.

5. The method of claim 4, wherein the encryption key and the first set of tags are received by the PLD in a data structure comprising the security signature.

6. The method of claim 1, wherein one or more of the encryption key, the first set of tags, and/or the encrypted configuration bitstream are received by the PLD from an external system and/or a storage device associated with the PLD.

7. The method of claim 1, wherein the first set of tags are generated during an encryption operation that provides the encrypted configuration bitstream.

8. The method of claim 7, wherein:
the encryption operation is an Advanced Encryption Standard with Galois/Counter Mode (AES-GCM) encryption operation; and
the first set of tags are GCM tags.

9. The method of claim 1, further comprising configuring the PLD with a decrypted configuration bitstream in response to the comparing of the first and second tags.

10. The method of claim 1, wherein:
the encryption key and the first set of tags are uniquely associated with the encrypted configuration bitstream;
the encrypted configuration bitstream is a first encrypted configuration bitstream;
the encryption key is a first encryption key; and
the method further comprises:
receiving a second encryption key for a second encrypted configuration bitstream for the PLD,
receiving a third set of tags for the second encrypted configuration bitstream,
wherein the second encryption key and the third set of tags are uniquely associated with the second encrypted configuration bitstream,
receiving the second encrypted configuration bitstream separately from the second encryption key and the third set of tags,
decrypting the second encrypted configuration bitstream using the second encryption key to generate a fourth set of tags, and
comparing the third and fourth sets of tags to perform an integrity check for the second encrypted configuration bitstream.

11. A programmable logic device (PLD) comprising:
a plurality of logic blocks configured to:
receive an encryption key for an encrypted configuration bitstream for the PLD,
receive a first set of tags for the encrypted configuration bitstream,
receive the encrypted configuration bitstream separately from the encryption key and the first set of tags; and
dedicated hardware blocks implemented to:
decrypt the encrypted configuration bitstream using the encryption key to generate a second set of tags, and
compare the first and second sets of tags to perform an integrity check for the encrypted configuration bitstream.

12. The PLD of claim 11, wherein the logic blocks are configured to authenticate the encryption key and the first set of tags.

13. The PLD of claim 12, wherein the logic blocks are configured to verify a security signature associated with the encryption key and the first set of tags to authenticate the encryption key and the first set of tags.

14. The PLD of claim 13, wherein the encryption key and the first set of tags are received by the PLD in a data structure comprising the security signature.

15. The PLD of claim 11, wherein the logic blocks are configured to receive one or more of the encryption key, the first set of tags, and/or the encrypted configuration bitstream from an external system and/or a storage device associated with the PLD.

16. The PLD of claim 15, wherein the logic blocks are configured to establish a secure communication channel with the external system, wherein the encryption key and the first set of tags are received over the secure communication channel.

17. The PLD of claim 11, wherein the first set of tags are generated during an encryption operation that provides the encrypted configuration bitstream.

18. The PLD of claim 17, wherein:
the encryption operation is an Advanced Encryption Standard with Galois/Counter Mode (AES-GCM) encryption operation; and
the first set of tags are GCM tags.

19. The PLD of claim 11, further comprising a configuration engine implemented to configure the logic blocks with a decrypted configuration bitstream in response to the comparing of the first and second tags.

20. The PLD of claim 11, wherein:
the encryption key and the first set of tags are uniquely associated with the encrypted configuration bitstream;
the encrypted configuration bitstream is a first encrypted configuration bitstream;
the encryption key is a first encryption key;
the logic blocks are configured to:
receive a second encryption key for a second encrypted configuration bitstream for the PLD,
receive a third set of tags for the second encrypted configuration bitstream,
wherein the second encryption key and the third set of tags are uniquely associated with the second encrypted configuration bitstream, and
receive the second encrypted configuration bitstream separately from the second encryption key and the third set of tags; and
the dedicated hardware blocks are implemented to:
decrypt the second encrypted configuration bitstream using the second encryption key to generate a fourth set of tags, and
compare the third and fourth sets of tags to perform an integrity check for the second encrypted configuration bitstream.
